(19) United States
(12) Patent Application Publication
(10) Pub. No.: US 2002/0038977 A1
(43) Pub. Date: Apr. 4, 2002

(54) Hydraulic brake system for vehicle

(76) Inventors: Hirofumi Nitta, Obu-shi (JP); Michiharu Nishii, Toyota-shi (JP); Tadashi Terazawa, Toyota-shi (JP); Masaki Oishi, Toyota-shi (JP)

Correspondence Address: Platon N. Mandros, Esquire, BURNS, DOANE, SWECKER & MATHIS, L.L.P., P.O. Box 1404, Alexandria, VA, 22313-1404, US

(21) Appl. No.: 09/963,395

(22) Filed: Sep. 27, 2001

(30) Foreign Application Priority Data
Sep. 27, 2000 (JP) 2000-295250

(51) Int. Cl. B60T 8/32

(52) U.S. Cl. 303/138

(57) ABSTRACT

A vehicle hydraulic brake system includes a hydraulic pressure generator which pressurizes brake fluid supplied from a reservoir to apply brake pressure to a wheel cylinder in response to operation of a brake member, an auxiliary hydraulic pressure source having an accumulator and a hydraulic pump that pressurizes brake fluid supplied from the reservoir to a predetermined level for generating power hydraulic pressure, and an output hydraulic pressure detector for continuously detecting an output hydraulic pressure of the accumulator. A vehicle condition detector continuously detects an operating condition of the vehicle and a driving condition setting device sets a driving condition of the hydraulic pump based on the detected operating condition of the vehicle. A driving control device controls the hydraulic pump based on the driving condition of the hydraulic pump set by the driving condition setting device and the output hydraulic pressure of the accumulator.

### FIELD OF THE INVENTION

The present invention is generally related to a hydraulic brake system for a vehicle. More specially, the present invention pertains to a vehicle hydraulic brake system having, in addition to a hydraulic pressure source which supplies hydraulic pressure in response to brake operation, an auxiliary hydraulic pressure source pressurizing brake fluid through use of a hydraulic pump.

### BACKGROUND OF THE INVENTION

One known type of hydraulic brake system includes a master cylinder serving as a hydraulic pressure generator for supplying hydraulic pressure in response to brake operation and an auxiliary hydraulic pressure source including a hydraulic pump and an accumulator. In this hydraulic brake system, it is necessary to control the hydraulic pressure outputted from the auxiliary hydraulic pressure source. In addition, it is necessary to issue a warning when the hydraulic pressure drops.

U.S. Pat. No. 5,000,520 discloses a hydraulic brake system. In its discussion of the operation of other known hydraulic brake systems, the patent states that the auxiliary pressure can vary within given limits of, for example, within 140 to 180 bar. The patent also describes that in these systems, the hydraulic pump is switched on as soon as the auxiliary pressure drops to the lower limit and remains in operation until the upper limit is reached. If, due to a defect for example, the auxiliary pressure drops below the lower limit and reaches an auxiliary pressure minimum set at 105 bar, the patent states that a warning signal is produced.

U.S. Pat. No. 5,000,520 proposes a switching arrangement for controlling the hydraulic pump of an auxiliary pressure supply system in which a switching contact of a motor relay turns on or off an electric motor that drives the hydraulic pump. When the switching contact of the motor relay is defective, a sole pressure switch and sole switching relay are provided to maintain the output hydraulic pressure of the auxiliary hydraulic pressure source within a predetermined pressure range, to issue the warning signal by another pressure switch when the accumulator pressure drops below its lower limit, and to drive the motor by another switching relay.

According to the system described in U.S. Pat. No. 5,000,520, the hydraulic pump can operate even if the accumulator pressure drops, and so it is possible to maintain the driving state of the hydraulic pump. However, maintaining the accumulator pressure within the pressure range by the sole pressure switch may result in the accumulator pressure being maintained at a higher pressure level than the desired pressure level, thus causing wasteful consumption of the energy for driving the hydraulic pump. In addition, to cope with the sole pressure switch operation, the capacity of the accumulator has to be made sufficient, resulting in the need for a larger accumulator.

A need thus exists for a hydraulic brake system that is not as susceptible to the same disadvantages and drawbacks mentioned above.

### SUMMARY OF THE INVENTION

In accordance with one aspect of the present invention, a hydraulic brake system for a vehicle includes a hydraulic pressure generating device for pressurizing brake fluid supplied from a reservoir to apply a brake pressure to a wheel cylinder in response to operation of a brake operating member, an auxiliary hydraulic pressure source having an accumulator and a hydraulic pump that pressurizes the brake fluid supplied from the reservoir to a predetermined level for generating a power hydraulic pressure, and an output hydraulic pressure detecting device for continuously detecting an output hydraulic pressure of the accumulator of the auxiliary hydraulic pressure source. A vehicle condition detecting device continuously detects an operating condition of the vehicle, a driving condition setting device sets a driving condition of the hydraulic pump based on the operating condition of the vehicle detected by the vehicle condition detecting device, and a driving control device controls the hydraulic pump based on the driving condition of the hydraulic pump set by the driving condition setting device and the output hydraulic pressure of the accumulator of the auxiliary hydraulic pressure source.

The hydraulic brake system thus continuously observes the power hydraulic pressure outputted by the auxiliary hydraulic pressure source and also continuously observes the operating condition of the vehicle, and then sets the driving condition of the hydraulic pump based on the operating condition. The hydraulic brake system is thus constructed to control the operation of the hydraulic pump based on the driving condition and the power hydraulic pressure. Accordingly, the hydraulic brake system can appropriately control the hydraulic pump, whereby the hydraulic brake system obtains or provides a good brake feel. Additionally, energy efficiency and durability of the hydraulic pump are improved.

The driving condition setting device includes a stop judging mechanism for judging whether or not the vehicle is stopping, and sets the driving condition of the hydraulic pump so that the output hydraulic pressure of the auxiliary hydraulic pressure source is smaller when the stop judging mechanism judges that the vehicle is stopped than the output hydraulic pressure when the stop judging mechanism judges that the vehicle is running. When the vehicle is judged to be stopped, the vehicle hydraulic brake system sets the driving condition for the hydraulic pump to generate a lower power hydraulic pressure compared to the power hydraulic pressure when the vehicle is judged to be running. Accordingly, the noise of the hydraulic pump is reduced, while at the same time improving the energy efficiency and durability of the hydraulic pump.

The vehicle condition detecting device includes a brake operation amount detecting mechanism for detecting the operating amount of the brake operating member and a deceleration detecting mechanism for detecting a deceleration of the vehicle. The driving condition setting device judges whether or not a brake fade occurs based on the operating amount detected by the brake operation amount detecting mechanism and the deceleration detected by the deceleration detecting mechanism. The driving condition setting device sets the driving condition of the hydraulic pump so that the output hydraulic pressure of the auxiliary hydraulic pressure source is larger when the driving condition setting device judges that brake fade occurs than the output hydraulic pressure under normal braking operation.

The vehicle hydraulic brake system thus judges whether or not the brake fade occurs based on the operating amount of the brake operating member and the deceleration of the vehicle body. When the hydraulic brake system judges the occurrence of brake fade, the driving condition for the hydraulic pump is set in order that the auxiliary hydraulic pressure source outputs the power hydraulic high. Accordingly, the hydraulic brake system is able to appropriately control the hydraulic pump. Also, the hydraulic brake system is able to produce the required braking force even if brake fade occurs.

The hydraulic pressure generating device includes a master cylinder and a hydraulic booster that assists the operation of the master cylinder by using the power hydraulic pressure generated by the auxiliary hydraulic pressure source. The output hydraulic pressure detecting device includes a first pressure sensor for detecting the hydraulic pressure of the auxiliary hydraulic pressure source.

The vehicle condition detecting device includes at least one of a wheel sensor detecting a wheel speed of the vehicle, a stroke sensor detecting a stroke amount of the brake operating member, a vehicle height sensor detecting a height of the vehicle, and a second pressure sensor detecting the brake pressure generated by the hydraulic pressure generating device.

The driving condition setting device includes a stop judging mechanism for judging whether or not the vehicle is stopped. The driving condition setting device then sets the driving condition of the hydraulic pump so that the output hydraulic pressure of the auxiliary hydraulic pressure source is smaller when the stop judging mechanism judges that the vehicle is stopped than the output hydraulic pressure when the stop judging mechanism judges that the vehicle is running. The vehicle condition detecting device also includes a brake operation amount detecting mechanism for detecting an operating amount of the brake operating member and a deceleration detecting mechanism for detecting the deceleration of the vehicle. The driving condition setting device judges whether or not a brake fade occurs based on the operating amount detected by the brake operation amount detecting mechanism and the deceleration detected by the deceleration detecting mechanism, with the driving condition setting device setting the driving condition of the hydraulic pump so that the output hydraulic pressure of the auxiliary hydraulic pressure source becomes larger when the driving condition setting device judges that brake fade occurs than the output hydraulic pressure under normal braking operation.

The auxiliary hydraulic pressure source also includes an electric motor for driving the hydraulic pump, with the accumulator being connected at an output side of the hydraulic pump.

In accordance with another aspect of the invention, a hydraulic brake system for a vehicle includes a hydraulic pressure generating device which generates pressurizing brake fluid supplied from a reservoir to apply a brake pressure to a wheel cylinder in response to operation of a brake operating member, an auxiliary hydraulic pressure source having an accumulator and a hydraulic pump that pressurizes the brake fluid supplied from the reservoir to a predetermined level for generating a power hydraulic pressure, and an output hydraulic pressure detector for continuously detecting an output hydraulic pressure of the accumulator of the auxiliary hydraulic pressure source. A vehicle condition detector continuously detects at least one of a plurality of operating conditions of the vehicle, including whether the vehicle is in a stopped condition or a running condition, whether a vehicle load is greater than or less than a predetermined value, the absence or presence of an automatic braking condition, the absence or presence of a sudden breaking condition, and the absence or presence of a brake fade occurrence. A driving condition setting device sets a first driving condition of the hydraulic pump when the vehicle condition detector detects at least one of the stopped condition of the vehicle, the vehicle load being less than the predetermined value, the absence of the automatic braking condition, the absence of the sudden breaking condition and the absence of brake fade occurrence, and sets a second driving condition higher than the first driving condition when the vehicle condition detector detects at least one of the running condition of the vehicle, the vehicle load being greater than the predetermined value, the presence of the automatic braking condition, the presence of the sudden breaking condition and the presence of brake fade occurrence. A driving controller controls the hydraulic pump based on either the first or second driving condition set by the driving condition setting device and the output hydraulic pressure of the accumulator of the auxiliary hydraulic pressure source.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a schematic block diagram of a hydraulic brake system in accordance with the present invention.

FIG. 2 is a graph showing limit values for the control operation of accumulator hydraulic pressure in accordance with the present invention.

FIG. 3 shows a schematic block diagram of an electronic control device used in the present invention.

FIG. 4 shows a flowchart of the driving control operation of the hydraulic pump in accordance with the present invention.

FIG. 5 is a graph showing the relationship between the hydraulic pressure of a master cylinder and braking force of a general hydraulic brake system.

FIG. 6 is a graph showing the relationship between the hydraulic pressure of a master cylinder and the braking force employed in the judgment of a brake fade.

FIG. 7 is a graph showing the limit values for another control operation of accumulator hydraulic pressure in accordance with the present invention.

### DETAILED DESCRIPTION OF THE INVENTION

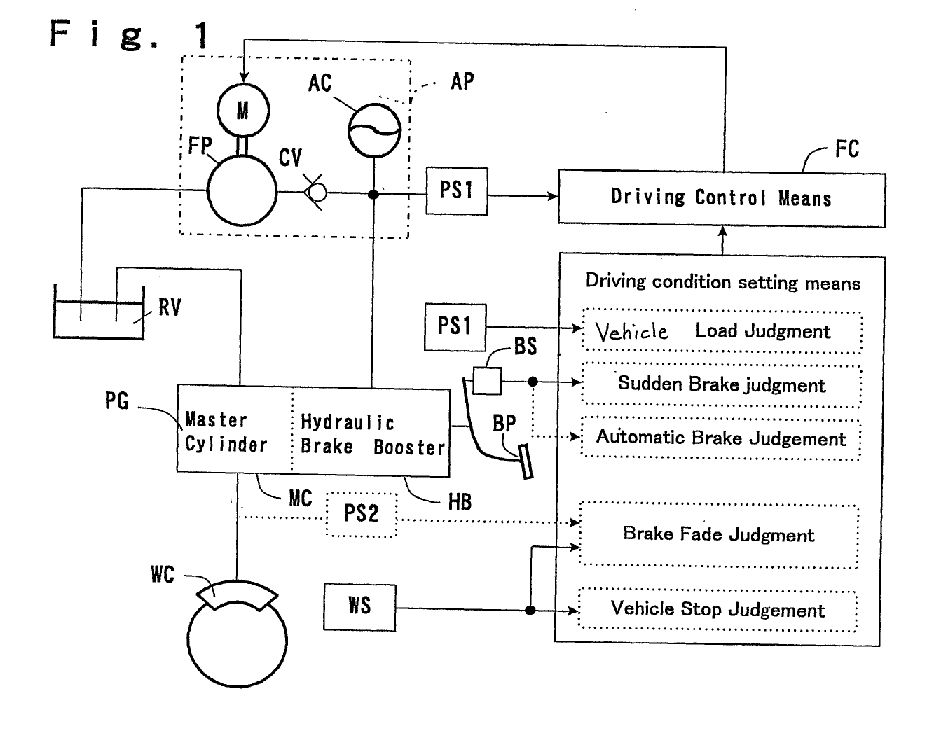

Referring initially to FIG. 1 which schematically illustrates the structure of the hydraulic brake system according to the present invention, the hydraulic brake control device includes a pressure generator PG and an auxiliary hydraulic pressure source AP. The pressure generator PG pressurizes brake fluid supplied from a reservoir RV in response to operation of a brake pedal BP which acts as a brake operating member, and outputs hydraulic pressure as pressurized brake fluid. The auxiliary hydraulic pressure source AP increases the pressure of the brake fluid supplied from the reservoir RV to a predetermined level by driving a hydraulic pump FP, and outputs a power hydraulic pressure. The hydraulic pump FP, which constitutes the auxiliary hydraulic pressure source AP or a part of the auxiliary hydraulic pressure source AP, is driven by an electric motor M. The hydraulic pump FP has an inlet side connected with the reservoir RV and an outlet side connected with an accumulator AC by way of a check-valve CV.

The accumulator AC is connected with a pressure sensor PS1 forming an output hydraulic pressure detecting means for continuously detecting an accumulator hydraulic pressure, i.e., the hydraulic pressure of the accumulator AC or the hydraulic pressure outputted from the auxiliary hydraulic pressure source AP. The hydraulic pump FP is controlled by a driving control means FC based on the hydraulic pressure detected by the pressure sensor PS1 and a driving condition set by a driving condition setting means DC which will be described in more detail below.

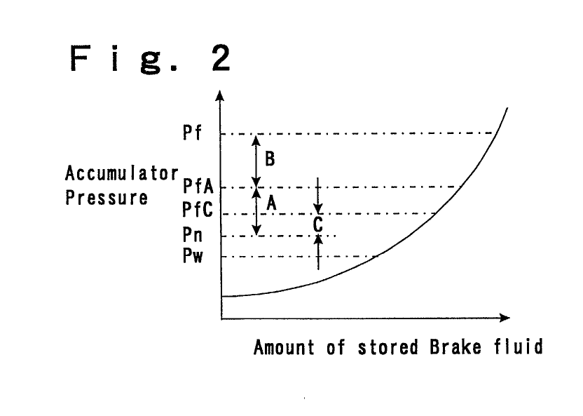

As shown in FIG. 2, the electric motor M is controlled to start when the accumulator hydraulic pressure reaches or becomes a lower limit Pn, and is further controlled to stop when the accumulator hydraulic pressure becomes or reaches an upper limit Pf. Between the lower limit and the upper limit, three pressure ranges A, B, C are defined, in order that the accumulator hydraulic pressure is set to be within any one of the three pressure ranges, with the driving control means FC controlling the electric motor M and further the hydraulic pump FP based on the driving condition set by the driving condition setting means DC. The bold solid line in FIG. 2 indicates an example of the relationship between a stored amount of the brake fluid in the accumulator AC and the accumulator hydraulic pressure when the auxiliary hydraulic pressure source AP is driven. In addition, the reference character Pw shown in FIG. 2 indicates a minimum standard hydraulic pressure (Pw<Pn). If the accumulator hydraulic pressure is less than the minimum standard hydraulic pressure, a warning is issued.

The pressure range A shown in FIG. 2 ranges from the lower limit Pn to a set pressure PfA, the pressure range B ranges from the set pressure PfA to the upper limit Pf, and the pressure range C ranges from the lower limit Pn to a set pressure PfC. The set pressure PfA is a pressure less than the upper limit pressure Pf and beyond or greater than the lower limit pressure Pn. The set pressure PfC is a pressure greater than the lower limit Pn and lower than the set pressure PfA.

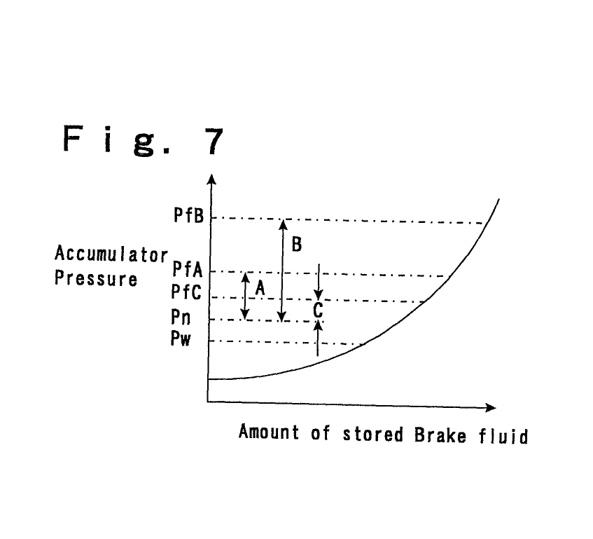

It is to be understood that the pressure ranges of the accumulator hydraulic pressure can alternatively be set as the pressure ranges shown in FIG. 7. Here, the pressure ranges A and C are identical with the pressure ranges A and C in FIG. 2, respectively. The pressure range B ranges from the lower limit Pn to the set pressure PfB. The set pressure PfB is a pressure higher than or greater than the set pressure PfA.

Referring once again to FIG. 1, the vehicle condition detecting means is provided with a wheel speed sensor WS detecting a wheel speed, a pedal stroke sensor BS detecting the stroke as the operational amount of the brake pedal which acts as the brake operation member, a vehicle height sensor HS detecting the height of the vehicle body relative to the road surface, and a pressure sensor PS2 detecting the hydraulic pressure outputted by the pressure generator PG. Of course, the vehicle condition detecting means is not limited to these sensors, and can include one or more other sensors.

The driving condition setting means DC is designed to judge whether or not the vehicle is stopped based on the wheel speed detected by the wheel speed sensor WS. If it is determined that the vehicle is stopped (i.e., the vehicle engine is operating, but the vehicle is stopped), the driving conditions of the hydraulic pump FP is set in order that the hydraulic pressure outputted from the auxiliary hydraulic pressure source AP (i.e., the accumulator hydraulic pressure) is set to be lower than that when it is determined that the vehicle is running. More specifically, if the vehicle is found to be running, the drive starting timing and the drive terminating timing of the hydraulic pump FP are set in order that the accumulator hydraulic pressure becomes within the pressure range A in FIG. 2. In other words, the drive starting timing is set when the accumulator hydraulic pressure exceeds the lower limit Pn, while the drive terminating timing is set when the accumulator hydraulic pressure reaches the set pressure PfA. On the other hand, while the vehicle is stopped, both the drive starting timing and the drive terminating timing of the electric motor M are set in order that the accumulator hydraulic pressure is within the pressure range C. That is, the driving starting timing is set when the accumulator hydraulic pressure exceeds the lower limit Pn (like when the vehicle is normally running), while the drive terminating timing is set when the accumulator hydraulic pressure reaches the set pressure PfC.

It is noted that in the described and illustrated embodiment, the driving current (driving duty) of the electric motor is set to the maximum (100%). However, for reducing noise while the electric motor M is driven, the driving current (driving duty) of the electric motor can be set to less than the maximum. The driving current (the driving duty) of the electric motor M can be set to the maximum (100%) for improving the responsiveness while the vehicle is running and can be smaller than the maximum while the vehicle is stopped.

In addition, according to the driving condition setting means DC of the present embodiment, the weight of the load on the vehicle (i.e., a vehicle load) is determined based on the output signal from the vehicle height sensor HS. If the vehicle load is found to be large, the diving condition of the hydraulic pump FP is set for making the accumulator hydraulic pressure larger than that when the vehicle load is small, whereby the drive starting and terminating timings are set in order that the accumulator hydraulic pressure is within the pressure range B. Moreover, a determination is made of whether or not an automatic brake control is active, and whether or not an urgent brake operation has been performed. When the automatic brake control is active or the urgent brake operation has been performed, the drive starting and terminating timings are set in order that the accumulator pressure is within the pressure range B. It is to be noted that in each of such cases the driving current (the driving duty) of the electric motor M is set to the maximum (100%).

In accordance with the driving condition setting means DC of the disclosed embodiment, a judgment is also made concerning whether or not a brake fade occurs based on the detection result of the pressure sensor PS2 and the wheel speed detected by the wheel speed sensor WS. If it is judged that the brake fade occurs, the drive starting and terminating timings are set in order that the accumulator hydraulic pressure is within the pressure range B in FIG. 2, as will be described in more detail below. Of course, instead of the pressure sensor PS2, the stroke sensor BS can be used to detect the brake fade.

When the vehicle load is small, or when the automatic brake control is inactive, or when the vehicle is not in the urgent brake operation but is in the normal brake operation, or when the brake fade does not occur, the drive starting and terminating timings are set in order that the accumulator hydraulic pressure is within the pressure range A in FIG. 2.

As shown in FIG. 1, the pressure generator PG includes a master cylinder MC and a hydraulic pressure booster HB which assists the operation of the master cylinder MC by using the power hydraulic pressure outputted from the auxiliary hydraulic pressure source AP. The pressure generator PG further can be provided with the pressure sensor PS2 which continuously detects the hydraulic pressure outputted by the master cylinder MC. The output signal of the pressure sensor PS2 (i.e., the detected result) is available or can be sued for checking whether or not the automatic brake control is active, or whether or not the vehicle is under the urgent brake operation.

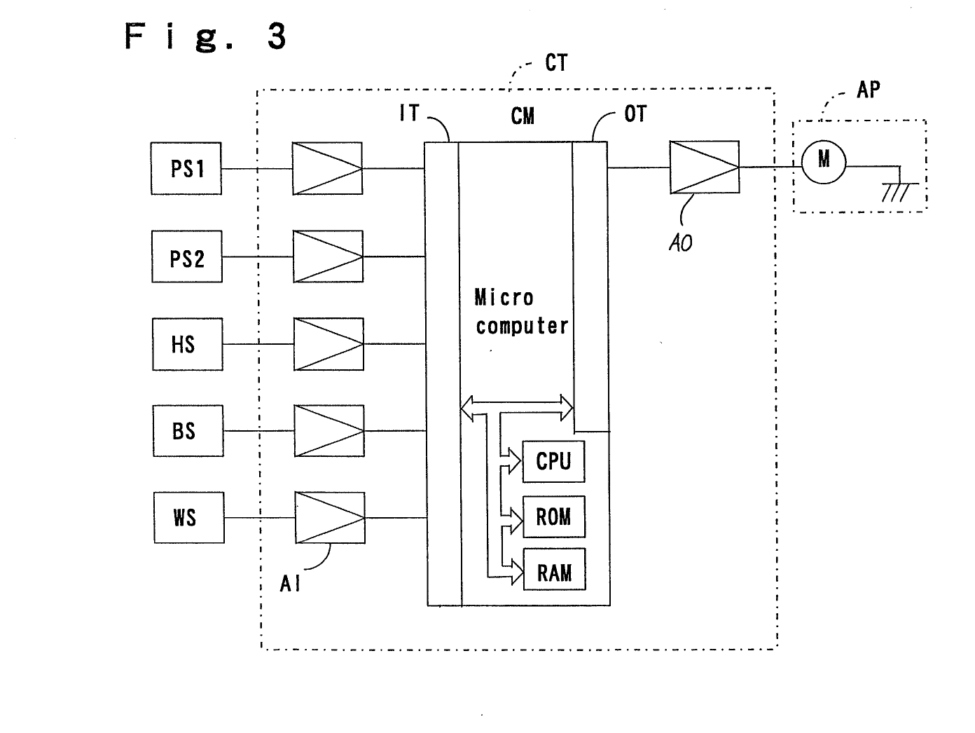

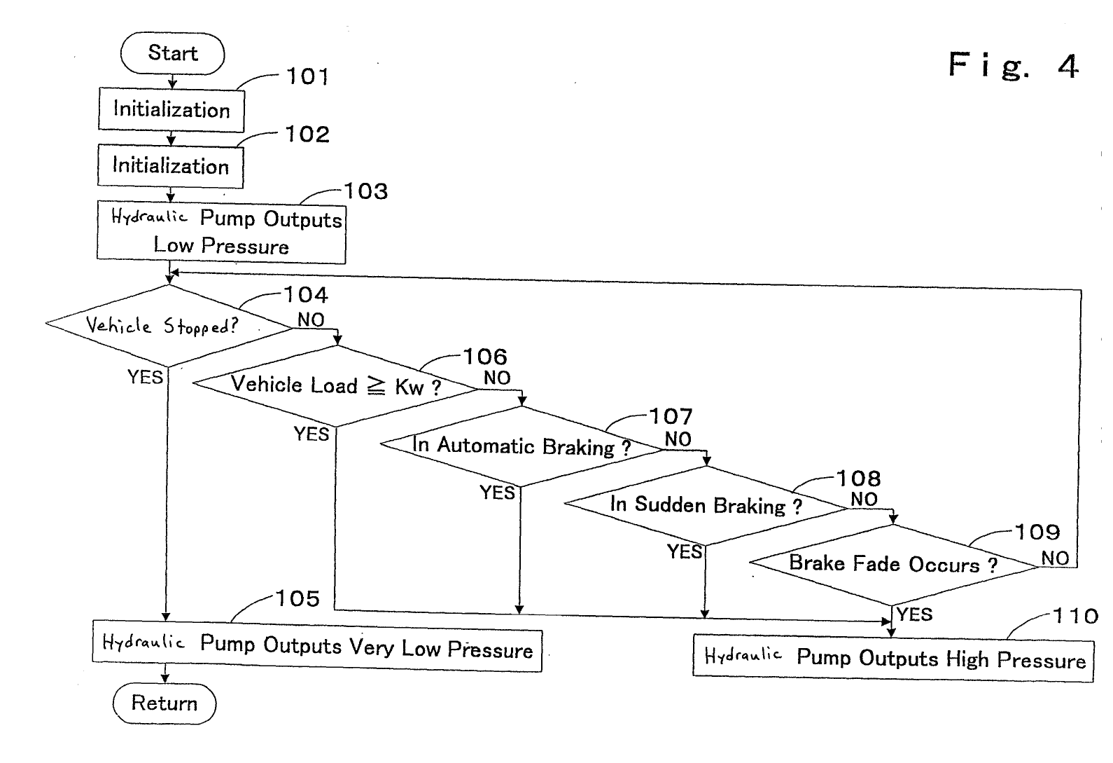

The aforementioned driving condition setting means DC, for example, is constructed in an electronic control device CT as shown in FIG. 3. The electronic control device CT is connected with the pressure sensor PSI and other sensors, and controls the electric motor M. As shown in FIG. 3, the electronic control device CT is provided with a microcomputer CM formed by electronic devices, a CPU, a ROM, a RAM, an input interface IT and an output interface OT which are constructed to be mutually connected by way of buses. The output signals of the aforementioned pressure sensor PS1 and others are fed from the input interface IT to the CPU by way of an amplifier circuit Al. A control signal is outputted from the output interface OT to the electric motor M by way of a driving circuit AO. In the micro computer CM, the ROM stores a program corresponding to the flowchart shown in FIG. 4, the CPU executes the program while an ignition key (not shown) is being turned on, and the RAM temporally stores variables required for executing the program.

In the above hydraulic brake system, the electronic control device CT performs a series of operations for effecting the driving control of the hydraulic pump FP, and the microcomputer CM begins to execute the program immediately when the ignition key (not shown) is turned on. Hereinafter, the procedure for the driving control of the hydraulic pump FP will be described with reference to the flowchart in FIG. 4. The drive starting and terminating of the hydraulic pump FP and the controlling of the accumulator hydraulic pressure are as described above and so a flowchart illustrating such characteristics is not included.

First, at step 101 the microcomputer CM is initialized to clear all the variables stored therein. Next, at step 102 the output signals from the wheel speed sensor WS and other sensors are fed into the microcomputer CM. Then the program proceeds to step 103 where the hydraulic pump FP is driven to output a low power hydraulic pressure, whereby the electric motor M is driven or operated so that the accumulator hydraulic pressure is within the pressure range A in FIG. 2. At step 104, the CPU judges whether or not the vehicle is stopped. When the CPU judges that the vehicle is stopped, the program proceeds to step 105, and the hydraulic pump FP is driven to output a very low power hydraulic pressure, whereby the electric motor M is driven or operated so that the accumulator hydraulic pressure is within the pressure range C in FIG. 2. Thus electric power consumed by the electric motor M is reduced to improve energy efficiency, thus improving the durability of the hydraulic pump FP and the hydraulic pressure booster HB. Also, the sound generated while the electric motor M is driven in this manner is relatively small and so the noise associated with the overall hydraulic pump is reduced.

At step 104, when the CPU judges that the vehicle is running, the program proceeds to step 106 and the subsequent steps to check whether or not the conditions for driving the hydraulic pump FP to output a very high power hydraulic pressure are satisfied. First, at step 106, the vehicle load is estimated based on the output signal from the vehicle height sensor HS, and is compared to a predetermined value Kw. If the vehicle load is found to be equal to or greater than the predetermined value Kw, the program proceeds to step 110 to drive the hydraulic pump FP to output the high power hydraulic pressure. In this situation, the electric motor M is controlled so that the accumulator hydraulic pressure is within the pressure range B in FIG. 2. If the vehicle load is found to be less than the predetermined value Kw, the program proceeds to step 107.

At step 107, the CPU judges whether or not the automatic brake control is active. More specifically, the electronic control device CT determines whether or not automatic brake control such as traction control, braking steering control, or inter-vehicle distance control is necessary based on an operating condition of the vehicle. When the electronic control device CT judges that the automatic brake control is necessary, an automatic brake control flag is set. The automatic brake control is deemed to be active when the automatic brake control flag is set. Alternatively, the automatic brake control can be deemed to be active when the brake pedal is not found to be depressed based on the output signal from a brake switch or the stroke sensor BS, or when the hydraulic pressure is found to be supplied by the master cylinder MC based on the output signal from the pressure sensor PS2, or when the accumulator hydraulic pressure is found to be beyond the predetermined value based on the output signal from the pressure sensor PSI.

At step 107, when the CPU judges that the automatic brake control is active, the program proceeds to step 110 to drive the hydraulic pump FP to output the high hydraulic pressure. If the CPU judges that the automatic brake control is inactive, the program proceeds to step 108 to check whether or not the urgent or sudden brake operation is done or completed. Here, the differential value of the stroke detected by the stroke sensor BS (or the differential value of the hydraulic pressure in the master cylinder MC detected by the pressure sensor PS2) is determined, whereupon it is judged whether or not the differential value is beyond a predetermined reference value. When the differential value is beyond the predetermined reference value, the urgent brake operation is found to be done or completed, whereby the program proceeds to step 110 to drive the hydraulic pump FP to output the hydraulic pressure high.

When the urgent brake operation is not found to be done, the program proceeds to step 109 to check whether or not the brake fade occurs. When the CPU judges that the brake fade occurs, the program proceeds to step 110 to drive the hydraulic pump to output the high hydraulic pressure. When the brake fade is deemed to not be occurring, the program returns to step 104. Thus, the program utilized in this described and illustrated embodiment is constructed to proceed to step 110 when the condition specified in any one of the steps 106-109 is satisfied. Alternatively, the program can be constructed to go step 110 when some conditions of all steps 106-109 are satisfied or when a combination of conditions of any of steps 106-109 is satisfied.

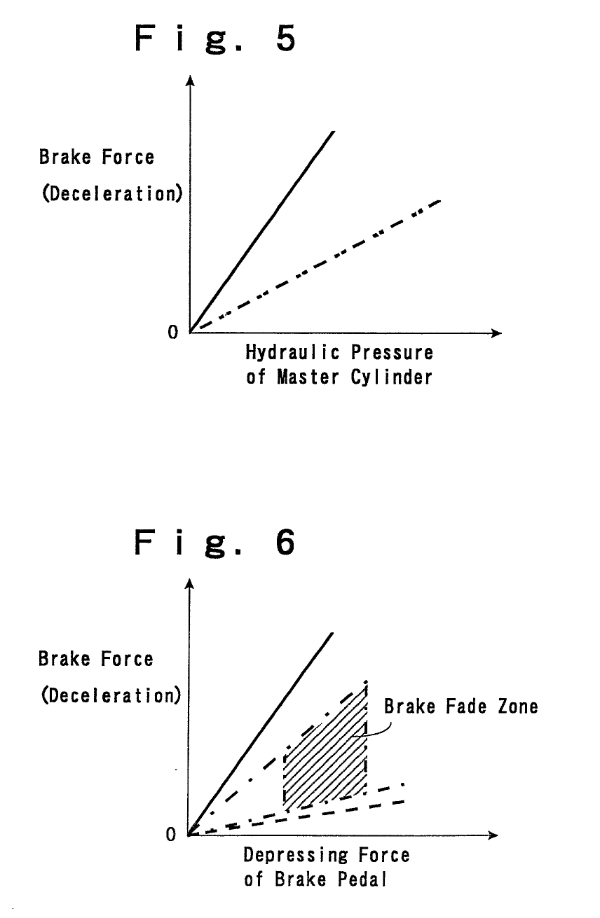

At step 109, it is determined whether or not the brake fade occurs as described below. The friction coefficient of a brake pad becomes gradually smaller as the friction surface of the brake pad becomes heated through repeated braking operation. In such a case, it is desirable to increase the braking force. However, it may be difficult to detect whether or not the brake fade occurs. When the brake fade occurs, the braking force (i.e., deceleration) drops or is reduced as shown by the two-dotted line in FIG. 5 which is positioned below the solid line representing the normal braking force. Even if the braking force drops or is reduced, it may not be possible to estimate that the brake fade occurs.

In view of this, in the present embodiment, by continuously detecting how the braking force relative to the brake pedal input force changes, the brake fade occurrence zone can be defined as noted by the area enclosed by the one-dotted lines in FIG. 6. It is to be noted that the solid line in FIG. 6 indicates the characteristics when the braking operation is normal and the two-dotted line in FIG. 6 indicates the characteristics when the auxiliary hydraulic pressure source AP is in failure.

As shown in FIG. 1, the driving condition setting means DC is constructed to judge whether or not the brake fade occurs based on both the detected result from the pressure sensor PS2 and the speed detected by the wheel speed sensor WS. More specifically, an estimated vehicle body speed is first calculated based on the wheel speed detected by the wheel speed sensor WS. Next, a vehicle body acceleration (which includes a vehicle body deceleration) is calculated by differentiating the vehicle body speed. A relationship between the vehicle body acceleration and the brake pedal input force speed, which is detected by the pressure sensor PS2, is represented by a map, in which the brake fade occurrence zone is defined. The brake pedal input force can be replaced with, for example, a detected signal from a depression sensor or the pedal stroke which is represented by the detected signal from the stroke sensor BS. If the brake fade is deemed to occur, the driving starting and terminating timings of the electric motor M are set in order that the accumulator hydraulic pressure is within the pressure range B in FIG. 2.

The principles, preferred embodiments and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A hydraulic brake system for a vehicle comprising:
a hydraulic pressure generating device for pressurizing brake fluid supplied from a reservoir to apply a brake pressure to a wheel cylinder in response to operation of a brake operating member;
an auxiliary hydraulic pressure source having an accumulator and a hydraulic pump, the hydraulic pump pressurizing the brake fluid supplied from the reservoir to a predetermined level for generating a power hydraulic pressure;
an output hydraulic pressure detecting means for continuously detecting an output hydraulic pressure of the accumulator of the auxiliary hydraulic pressure source;
vehicle condition detecting means for continuously detecting an operating condition of the vehicle;
driving condition setting means for setting a driving condition of the hydraulic pump based on the operating condition of the vehicle detected by the vehicle condition detecting means; and
driving control means for controlling the hydraulic pump based on the driving condition of the hydraulic pump set by the driving condition setting means and the output hydraulic pressure of the accumulator of the auxiliary hydraulic pressure source.

2. The hydraulic brake system for a vehicle in accordance with claim 1, wherein the driving condition setting means includes a vehicle stop judging means for judging whether or not the vehicle is stopped, the driving condition setting means setting the driving condition of the hydraulic pump so that the output hydraulic pressure of the auxiliary hydraulic pressure source is smaller when the stop judging means judges that the vehicle is stopped than the output hydraulic pressure when the stop judging means judges that the vehicle is running.

3. The hydraulic brake system for a vehicle in accordance with claim 1, wherein the vehicle condition detecting means includes an operation amount detecting means for detecting an operating amount of the brake operating member and deceleration detecting means for detecting a deceleration of the vehicle, the driving condition setting means judging occurrence of brake fade based on the operating amount detected by the operation amount detecting means and the deceleration detected by the deceleration detecting means, and the driving condition setting means setting the driving condition of the hydraulic pump so that the output hydraulic pressure of the auxiliary hydraulic pressure source is larger when the driving condition setting means judges the occurrence of brake fade than the output hydraulic pressure under normal braking operation.

4. The hydraulic brake system for a vehicle in accordance with claim 1, wherein the hydraulic pressure generating device includes a master cylinder and a hydraulic booster assisting operation of the master cylinder by using the power hydraulic pressure generated by the auxiliary hydraulic pressure source.

5. The hydraulic brake system for a vehicle in accordance with claim 1, wherein the output hydraulic pressure detecting means includes a first pressure sensor for detecting the hydraulic pressure of the auxiliary hydraulic pressure source.

6. The hydraulic brake system for a vehicle in accordance with claim 1, wherein the vehicle condition detecting means includes at least one of a wheel sensor detecting a wheel speed of the vehicle, a stroke sensor detecting a stroke amount of the brake operating member, a vehicle height sensor detecting a height of the vehicle, and a second pressure sensor detecting the brake pressure generated by the hydraulic pressure generating device.

7. The hydraulic brake system for a vehicle in accordance with Claim 2, wherein the vehicle condition detecting means includes an operation amount detecting means for detecting an operating amount of the brake operating member and deceleration detecting means for detecting a deceleration of the vehicle, the driving condition setting means judging an occurrence of brake fade based on the operating amount detected by the brake operation amount detecting means and the deceleration detected by the deceleration detecting means, and the driving condition setting means setting the driving condition of the hydraulic pump so that the output hydraulic pressure of the auxiliary hydraulic pressure source is larger when the driving condition setting means judges the occurrence of brake fade than the output hydraulic pressure under normal braking operation.

8. The hydraulic brake system for a vehicle in accordance with claim 1, wherein the auxiliary hydraulic pressure source further includes an electric motor for driving the hydraulic pump and the accumulator is connected at an output side of the hydraulic pump.

9. A hydraulic brake system for a vehicle comprising:
a hydraulic pressure generating device for pressurizing brake fluid supplied from a reservoir to apply a brake pressure to a wheel cylinder in response to operation of a brake operating member;
an auxiliary hydraulic pressure source having an accumulator and a hydraulic pump, the hydraulic pump pressurizing the brake fluid supplied from the reservoir to a predetermined level for generating a power hydraulic pressure;
an output hydraulic pressure detecting means for continuously detecting an output hydraulic pressure of the accumulator of the auxiliary hydraulic pressure source;
vehicle condition detecting means for continuously detecting at least one of a plurality of operating conditions of the vehicle, including whether the vehicle is in a stopped condition or a running condition, whether a vehicle load is greater than or less than a predetermined value, the absence or presence of an automatic braking condition, the absence or presence of a sudden breaking condition, and the absence or presence of a brake fade occurrence;
driving condition setting means which sets a first driving condition of the hydraulic pump when the vehicle condition detecting means detects at least one of the stopped condition of the vehicle, the vehicle load being less than the predetermined value, the absence of the automatic braking condition, the absence of the sudden breaking condition and the absence of brake fade occurrence, and sets a second driving condition higher than the first driving condition when the vehicle condition detecting means detects at least one of the running condition of the vehicle, the vehicle load being greater than the predetermined value, the presence of the automatic braking condition, the presence of the sudden breaking condition and the presence of brake fade occurrence; and
driving control means for controlling the hydraulic pump based on either the first or second driving condition set by the driving condition setting means and the output hydraulic pressure of the accumulator of the auxiliary hydraulic pressure source.

10. The hydraulic brake system for a vehicle in accordance with claim 9, wherein the vehicle condition detecting means includes an operation amount detecting means for detecting an operating amount of the brake operating member and deceleration detecting means for detecting a deceleration of the vehicle, the driving condition setting means judging the presence brake fade occurrence based on the operating amount detected by the operation amount detecting means and the deceleration detected by the deceleration detecting means.

11. The hydraulic brake system for a vehicle in accordance with claim 9, wherein the hydraulic pressure generating device includes a master cylinder and a hydraulic booster assisting operation of the master cylinder by using the power hydraulic pressure generated by the auxiliary hydraulic pressure source.

12. The hydraulic brake system for a vehicle in accordance with claim 9, wherein the output hydraulic pressure detecting means includes a first pressure sensor for detecting the hydraulic pressure of the auxiliary hydraulic pressure source.

13. The hydraulic brake system for a vehicle in accordance with claim 9, wherein the vehicle condition detecting means includes at least one of a wheel sensor detecting a wheel speed of the vehicle, a stroke sensor detecting a stroke amount of the brake operating member, a vehicle height sensor detecting a height of the vehicle, and a second pressure sensor detecting the brake pressure generated by the hydraulic pressure generating device.

14. The hydraulic brake system for a vehicle in accordance with claim 9, wherein the auxiliary hydraulic pressure source further includes an electric motor for driving the hydraulic pump and the accumulator is connected at an output side of the hydraulic pump.
